(19) United States
(12) Patent Application Publication
(10) Pub. No.: US 2007/0071365 A1
(43) Pub. Date: Mar. 29, 2007

(54) Biodegradable lawnmower bag

(75) Inventors: Spencer Clark Stevens, Whitecourt (CA); Jason Alexander Falkner, Whitecourt (CA); Sheldon Wayne Huard, Whitecourt (CA)

Correspondence Address: JEAN M. MACHELEDT, 501 SKYSAIL LANE, SUITE B100, FORT COLLINS, CO, 80525-3133, US

(73) Assignee: BIXIA CANADA LTD.

(21) Appl. No.: 11/506,973

(22) Filed: Aug. 18, 2006

(30) Foreign Application Priority Data
Sep. 9, 2005 (CA) 2,518,715

(51) Int. Cl. A01D 43/06; B65D 30/02; B65D 33/00; B65D 33/28; A01D 43/00

(52) U.S. Cl. 383/33; 56/202; 383/1; 383/72; 383/907

(57) ABSTRACT

The present invention is a biodegradable bag used as a liner for a grass-catcher bag of a lawnmower. The bag is releasably secured to the grass-catcher bag using a clip. A compost accelerant is placed inside the bag to speed the decomposition of the bag and the lawn waste contained inside. Once filled with lawn waste, the bag may be closed using a drawstring cinch-top and then placed in a compost heap for decomposition. The bag is adapted for use with grass-catcher bags for side-discharge and rear-discharge lawnmowers.

### FIELD OF THE INVENTION

The present invention relates to the field of liner bags for use with lawnmower grass-catcher bag systems. More specifically, the present invention relates to biodegradable bags that are inserted into lawnmower grass-catcher bags for catching and composting grass clippings and other lawn waste.

### BACKGROUND OF THE INVENTION

The use of polyethylene-based plastic bags for removal and disposal of lawn waste is becoming an increasing problem for environmental reasons. Many municipal governments have created regulations disallowing the use of plastic bags for lawn waste removal in an attempt to eliminate their use and to decrease their environmental impact. These governments are encouraging, or even requiring, that leaves, lawn clippings and grass are composted, rather than disposed of in plastic bags.

U.S. Pat. No. 5,679,421 teaches a biodegradable bag that can be formed out of two-ply sheet materials, which are formed and connected together with the use of biodegradable materials. The material used to construct the biodegradable bag is such that the bag is highly resistant to the passage of liquid, while at the same time is completely biodegreadable when subjected to microbial activity (i.e. a composting environment). Although such biodegradable bags could be used for lawn waste, the prior art fails to disclose a biodegradable bag that can be used in combination with a lawnmower grass-catcher bag to eliminate the step of transferring clippings and/or lawn waste from the grass-catcher bag to a biodegradable bag. The prior art also fails to teach a system that speeds the composting process of grass clippings and/or lawn waste.

It is, therefore, desirable to provide a biodegradable bag that can be inserted into the grass-catcher bag of any lawnmower. It is also desirable to provide means for closing and carrying the biodegradable bag without spilling the lawn waste inside. Finally, it is also desirable to provide a biodegradable bag for grass clipping that contains a composting accelerant to ensure quick and efficient decomposition of the lawn waste.

### SUMMARY OF THE INVENTION

The present invention is a removable liner, in the form of a biodegradable bag, that is designed to securely fit inside the grass-catcher bag of any lawnmower. The biodegradable bag is inserted into the grass-catcher bag to collect glass clippings and lawn waste as the lawnmower is operated. The biodegradable bag may then be closed and left in an open-air environment for composting. For efficient composting, the biodegradable bag may further comprise a compost accelerant to increase the decomposition rate of the entire bag and its contents. Typically, the accelerant would comprise nitrogen. The compost accelerant is held in place against an interior sidewall of the bag by a thin layer of biodegradable paper tissue glued or taped to the inside of the bag.

The biodegradable bag has a tubular sidewall with one end closed to form a bottom and the other end left open to form a bag mouth. The biodegradable bag is made from recycled paper products for sturdy containment of lawn waste yet will easily decompose in a compostable environment. For rear-discharge lawnmowers, the biodegradable bag is, typically, rectangular or trapezoidal in cross-section to match the shape of the grass-catcher bag. For side-discharge lawnmowers, the biodegradable bag is, typically, circular or oblong in cross-section.

In operation, the biodegradable bag is inserted into the grass-catcher bag of a lawnmower. If needed, the bag may be folded to adapt to its size for different styles of lawnmowers. Flaps extending outwardly from the mouth of the bag are folded over the rim of the grass-catcher bag and may be secured in place using a horseshoe-shaped clip. Once the biodegradable bag is secured in place, grass clippings and lawn waste are deposited in the bag by the lawnmower. As the grass clippings enter the biodegradable bag, the moisture of the clippings degrade the tissue layer contained inside and allows the slow release of the compost accelerant thereby increasing the rate of decomposition for both the lawn waste and the biodegradable bag itself. Once the biodegradable bag is full, grass-catcher bag is removed from the lawn mower and the horseshoe clip is removed to release the biodegradable bag from the grass-catcher bag. A hemp twine disposed about the bag near the biodegradable bag near the bag mouth can be cinched tight to seal the opening of the biodegradable bag to prevent any lawn waste from escaping.

It is an object of the present invention to provide a biodegradable lawnmower bag that can be inserted into the grass-catcher component of any lawnmower, thereby eliminating the use of plastic garbage bags.

It is another object of the present invention to provide a biodegradable bag system for lawnmowers that is easy to use and encourages the composting of lawn waste.

It is yet another object of the present invention to provide a biodegradable bag system that can be easily assembled onto any style of lawnmower without hassle or spillage of the lawn waste.

Broadly stated, the present invention is a removable liner for a grass-catcher bag for a lawnmower, comprising: a bag having a tubular sidewall defining two ends, one of said ends closed off to define a bottom end and the other of said ends defining a bag mouth, said bag of a predetermined size and shape whereby said bag is adapted to be removably inserted, bottom end first, into said grass -catcher bags; and securing means for releasably securing said bag to said grass-catcher bag.

### BRIEF DESCRIPTION OF THE DRAWINGS

FIG. 1a is an isometric view of a representative embodiment of the present invention.

FIG. 1b is an isometric view of a first alternate representative embodiment of the present invention.

FIG. 2 is an isometric view of a representative embodiment of the present invention being inserted into a lawnmower grass-catcher bag.

FIG. 3 is an isometric view of a representative embodiment of the present invention installed in a lawnmower grass-catcher bag.

FIG. 4 is a front elevational view of a representative embodiment of the present invention installed in a lawnmower grass-catcher bag.

FIG. 5 is an isometric view of a second alternate embodiment present invention.

FIG. 6 is an isometric view of a second alternate embodiment of the present invention being installed in the lawnmower grass-catcher bag.

FIG. 7 is an perspective view of a second alternate embodiment of the present invention filled with lawn waste and being closed for placement in a compost heap.

### DETAILED DESCRIPTION OF THE PREFERRED EMBODIMENT

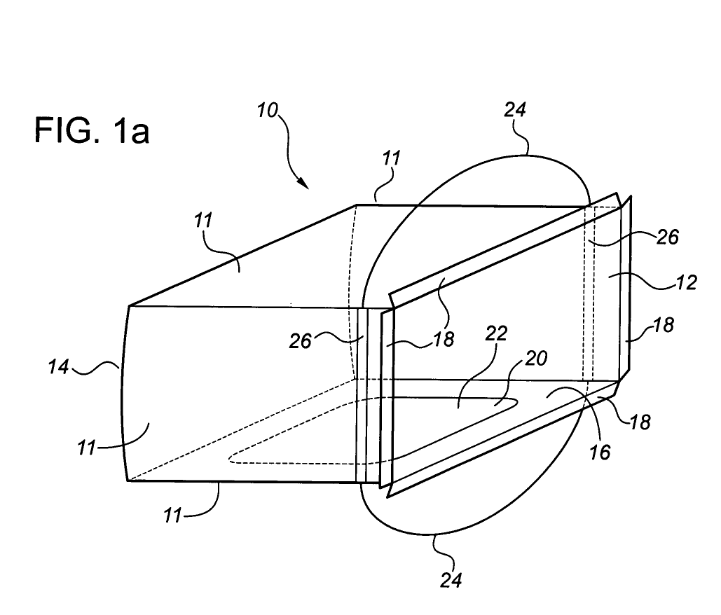

Referring to FIG. 1a, a representative embodiment of the present invention is illustrated. Bag 10 is a rectangular bag having four sidewalls 11, bottom 14 and bag mouth 12. Flaps 18 extend outwardly from sidewalls 11 and bag mouth 12. Tissue layer 20 holds a suitable amount of compost accelerant 22 against interior sidewall 16. It should be obvious to those skilled in the art as to the composition and amount of compost accelerant 22 to place in bag 10 is dependent on the volume of bag 10 and the type of lawn waste bag 10 will be used for. Compost accelerant 22 will at least comprise of nitrogen. Flaps 18 may, preferably, be reinforced with stitching along the edges of bag mouth 12. Drawstring 24 is loosely secured to bag 10 with strip layers 26 glued to the outside of sidewalls 11. Bag 10 and drawstring 24 are made of biodegradable materials. Preferably, bag 10 is made of recycled paper products and a drawstring 24 is made of hemp. Once bag 10 is filled with lawn waste, drawstring 24 can be used to cinch bag mouth 12 closed and to provide a handle to carry bag 10 to a composting area.

Referring to FIG. 1b, a first alternate representative embodiment of the present invention is shown. Instead of strip layers 26 securing drawstring 24 to bag 10, bag 10 comprises a plurality of holes 27 positioned around the perimeter of bag 10 near bag mouth 12. In this embodiment, drawstring 24 is woven through all of holes 27 with the ends of drawstring 24 tied together to form a continuous loop.

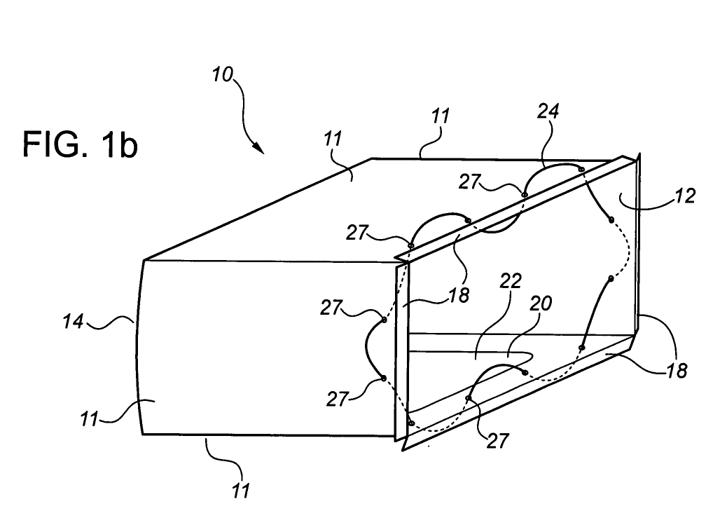

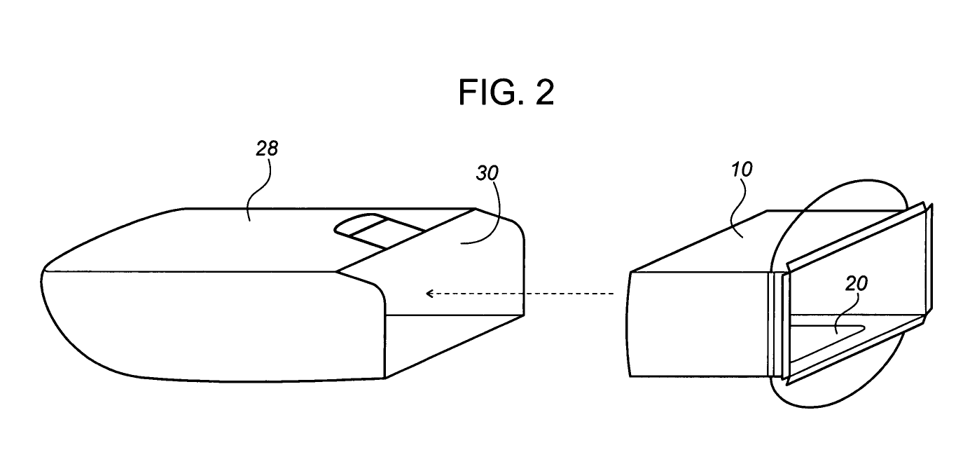

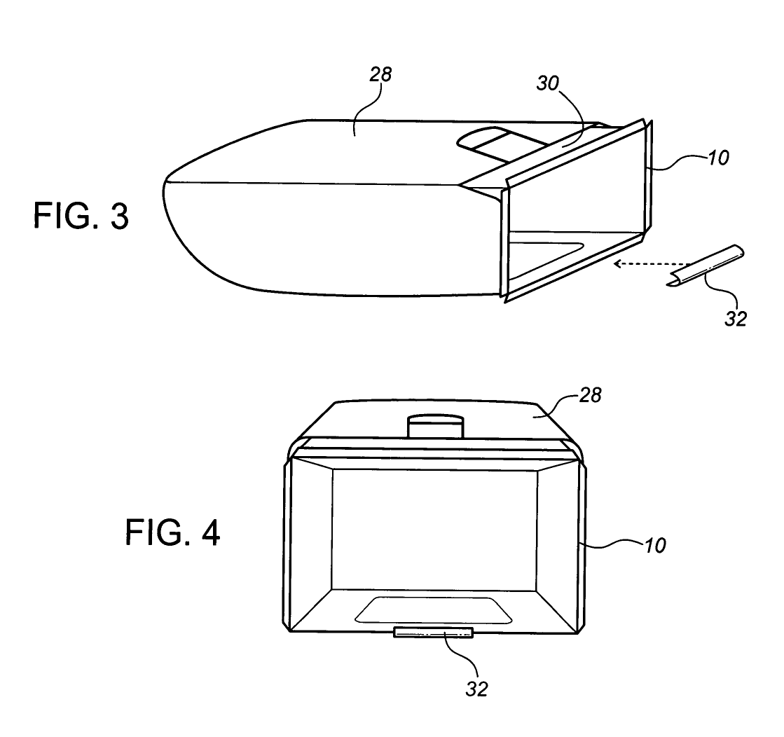

Referring to FIG. 2, bag 10 as shown being inserted into mouth 30 of grass-catcher bag 28. In this illustration, grass-catcher bag 28 is of the type used on a rear-discharge lawnmower. Referring to FIGS. 3 and 4, bag 10 is secured to grass-catcher bag 28 with at least one horseshoe-shaped clip 32. Clip 32 simply clips one edge of bag mouth 12 to grass-catcher bag 28.

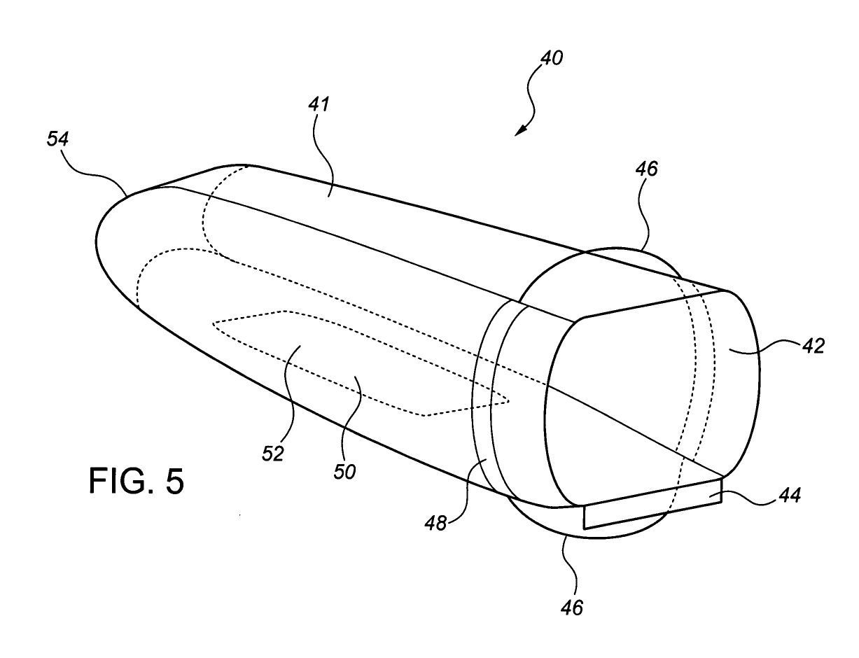

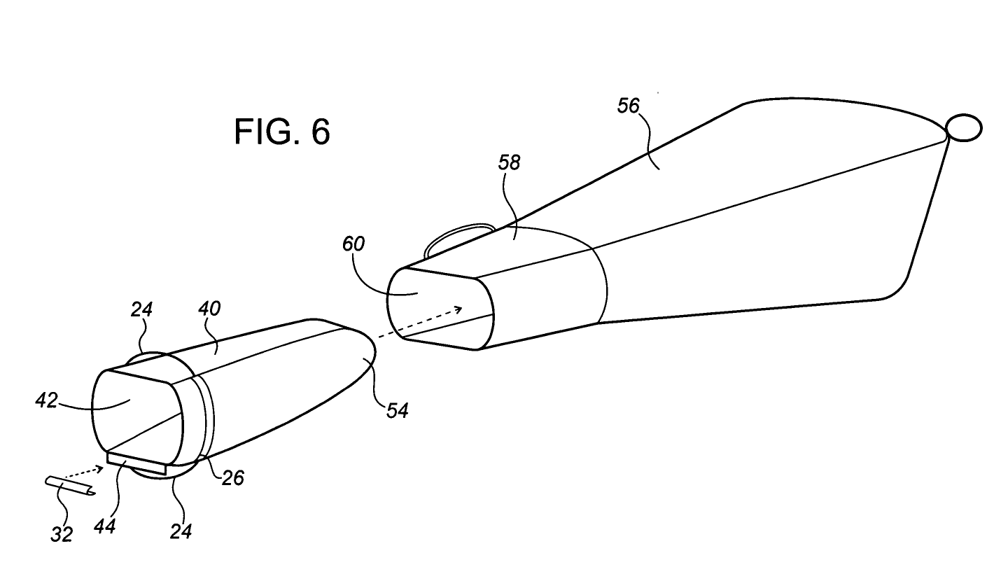

Referring to FIGS. 5 and 6, an alternate embodiment of the present invention is shown that is suitable for use with grass-catcher bags of side-discharge lawn mowers. Bag 40 has a tubular sidewall 41 and a bag mouth 42 at one end. The opposite end is closed off to form closed end 54. Closed end 54 may be simply tied off, either pointing outwardly or inwardly. Drawstring 46 is loosely secured to bag 40 with strip layers 48 glued to the outside of sidewall 41. Compost accelerant 52 is held in place inside bag 40 by tissue layer 50.

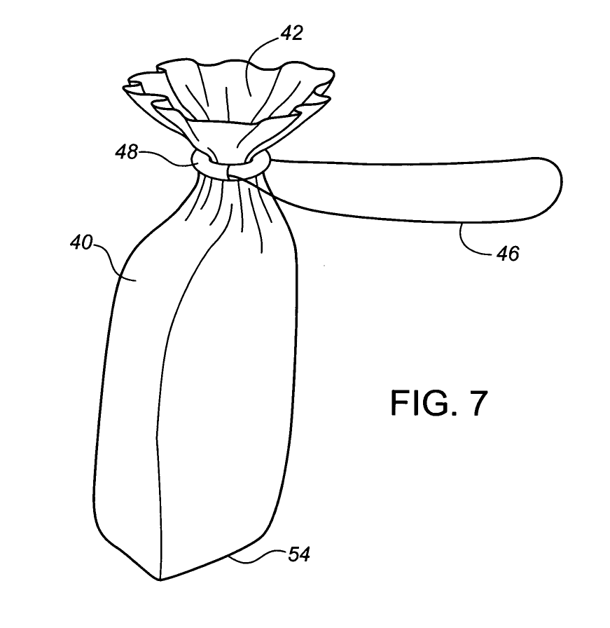

In operation, bag 40 is inserted into bag 56 by placing bottom end 54 through mouth 60 of chute 58 until flap 44 rests against mouth 60. Flap 44 is then folded over the edge of mouth 60 and held in place by clip 32. Referring to FIG. 7, when the contents of bag 40 are full, bag 40 is removed from grass-catcher bag 56 and bag mouth 42 is drawn shut by drawstring 46 and tied off. Bag 40 may then be placed in a compost heap where compost accelerant 52 speeds the decomposition of the contained grass clippings and of bag 40 itself.

Although a few preferred embodiments have been shown and described, it will be appreciated by those skilled in the art that various changes and modifications might be made without departing from the scope of the invention. The terms and expressions used in the preceding specification have been used herein as terms of description and not of limitation, and there is no intention in the use of such terms and expressions of excluding equivalents of the features shown and described or portions thereof, it being recognized that the scope of the invention is defined and limited only by the claims that follow.

We claim:

1. A removable liner for a grass-catcher bag for a lawnmower, comprising:
a) a bag having a tubular sidewall defining two ends, one of said ends closed off to define a bottom end and the other of said ends defining a bag mouth, said bag of a predetermined size and shape whereby said bag is adapted to be removably inserted, bottom end first, into said grass-catcher bag; and
b) securing means for releasably securing said bag to said grass-catcher bag.

2. The liner as set forth in claim 1 wherein said bag further comprises at least one flap extending substantially downwardly from said sidewall at said bag mouth whereby said at least one flap acts as a stop to prevent said bag from being inserted too far into said grass-catcher bag.

3. The liner as set forth in claim 1 wherein said securing means comprises a removable clip to hold said bag to said grass-catcher bag.

4. The liner as set forth in claim 3 wherein said clip is used to clip said bag mouth to said grass-catcher bag.

5. The liner as set forth in claim 1 further comprising a drawstring disposed about said sidewall near said bag mouth for closing off said bag.

6. The liner as set forth in claim 2 wherein said bag and said at least one flap are made of a biodegradable material.

7. The liner as set forth in claim 6 wherein said biodegradable material is reinforced recycled paper.

8. The liner as set forth in claim 5 wherein said drawstring is biodegradable.

9. The liner as set forth in claim 1 wherein said bag comprises a predetermined amount of compost accelerant contained therein.

10. The liner as set forth in claim 9 wherein said bag further comprises a layer of biodegradable tissue that encloses said compost accelerant to an interior wall of said bag, said tissue adapted to release said compost accelerant when said tissue becomes wet.

11. The liner as set forth in claim 9 wherein said compost accelerant comprises nitrogen.

12. The liner as set forth in claim 1 wherein said tubular sidewall is substantially circular or oblong in cross-section whereby said bag is adapted for use with a side-discharge lawnmower.

13. The liner as set forth in claim 1 wherein said tubular sidewall is substantially rectangular or trapezoidal in cross-section whereby said bag is adapted for use with a rear-discharge lawnmower.
